(19) United States
(12) Patent Application Publication
(10) Pub. No.: US 2005/0087686 A1
(43) Pub. Date: Apr. 28, 2005

(54) Method of observing defects

(76) Inventors: Toshifumi Honda, Yokohama (JP); Toshiro Kubo, Hitachinaka (JP)

Correspondence Address: ANTONELLI, TERRY, STOUT & KRAUS, LLP, 1300 NORTH SEVENTEENTH STREET, SUITE 1800, ARLINGTON, VA, 22209-9889, US

(21) Appl. No.: 10/954,421

(22) Filed: Oct. 1, 2004

(30) Foreign Application Priority Data
Oct. 3, 2003 (JP) 2003-345447

(51) Int. Cl. G01N 23/00; G21K 7/00

(52) U.S. Cl. 250/307; 250/311

(57) ABSTRACT

This invention provides a technique for observing defects, which can automatically decide a direction from inclined observation and take an inclined review image. In a defect observing system for detecting the defects and thereafter observing images of the defects from various directions in detail, positions of inclined images to be taken are automatically displayed on a display screen from a planar image (top-down image) of a SEM using CAD data, and the defects are selected from the images displayed on the display screen based on specification by a user, an inclined angle and direction are determined per selected image to take an inclined image (beam-tilt image), and the inclined image of each defect is acquired.

### CROSS-REFERENCE TO RELATED APPLICATION

The present application claims priority from Japanese patent application No. JP 2003-345447 filed on Oct. 3, 2003, the content of which is hereby incorporated by reference into this application.

### BACKGROUND OF THE INVENTION

The present invention generally relates to a technique for automatically observing defects of industrial products and more particularly to a technique effectively applied to a method of easily observing from various directions images of defects after pre-process detection of semiconductor products, the pre-process detection being important to detailed observation of the defects that has already been detected.

As a result of examinations by the inventors of the present invention, the following techniques are conceivable for observing defects.

For example, as semiconductors are miniaturized, it has become increasingly difficult to execute pre-process control in a manufacturing process of the semiconductors. Also, in process management that depends on fluctuations in the number of semiconductor defects detected by appearance examinations of semiconductor wafers, it has been no longer possible to manufacture the semiconductors with high yields. Thus, after the examinations by an appearance examining apparatus, the images of the defects obtained during the examinations have been generally observed by a detailed review apparatus.

The semiconductors are miniaturized year by year and new processes are introduced accordingly. Generally, when the new process is introduced, many defects inevitably occur because no accumulated know-how is available for the new process. Observations from inclined directions by an SEM are important in order to elucidate causes of occurrence of the defects. For example, it is possible to extrapolate from causes of occurrence of pattern-based detects in some cases by observing a sidewall of a wiring. Also, by observing a pattern of a foreign substance or a contact portion of it and an underlying layer, it is possible to determine in some cases whether the foreign substance matter is produced in the preceding step.

When unknown defects occur in introducing a new process etc., they are generally observed from the inclined directions by the SEM. As a method of taking inclined images using the SEM, for example, as a method of inclining and observing objects of the SEM, Japanese Patent Laid-open No. 2000-348658 (Patent Document 1) discloses a method of deflecting an electron beam irradiated from an electronic optical system and inclining irradiation directions of the electron beam to observational objects to take the inclined images. Further, a method for achieving inclined observation, for example, a method of inclining a stage per se for moving a wafer so as to observe any locations on the wafer by the SEM or a method of inclining mechanically the electronic optical system per se of the SEM is applied to a review SEM serving as the SEM for observing semiconductor defects.

### SUMMARY OF THE INVENTION

Meanwhile, regarding the above-mentioned technique for observing the defects, the followings have become apparent from the results examined by the inventors.

For example, the above-described conventional techniques are inconvenient to the inclined observation and it has been particularly difficult to utilize the inclined observation in mass production lines. In the inclined observation in the mass production lines, it is desirable to minimize a time required for taking the images in order to realize a high throughput, and to automatically take inclined images on the basis of coordinates of each position of defects detected by the examination apparatus.

The above-mentioned problem of the observation of the inclined images, using the method of deflecting the electron beams irradiated from the electronic optical system and changing a irradiated direction of the electron beam, makes it difficult to extrapolate a three-dimensional profile of the object if the object does not have a clearly edged structure and the three-dimensional profile of the objects of images to be taken is modestly changed.

Additionally, in the method of deflecting the incident angle of the electron beam, the incident angle can be inclined only by about ±15 degrees from the normal of the wafer. The inclination angle is limited further to about ±10 degrees when the image with high resolution needs to be taken. In such small inclination angle, appearances of the object viewed after the modest three-dimensional profile change are hardly changed, so that it is difficult to acquire useful information on the profile.

Further, the conventional review SEM in which the electronic optical system is mechanically inclined has a little restriction of the inclination angle, for example, can observe the object within a range of an inclination angle of about 0 to +60 degrees. Therefore, the change of the modest three-dimensional profile of the object can also be cleared by taking the image through such a large inclination angle. That is for the following reason. Since it takes, for example, about five minutes to incline the electronic optical system, the inclination angle cannot be changed with high speed. Additionally, the SEM requires that the wafer and the routes of the electron beams are all held in vacuum, so that the mechanism for inclining the electronic optical system is much complicated while the system is maintained airtightness. Therefore, the electronic optical system cannot be inclined with high speed.

Meanwhile, the method of inclining the stage can be implemented with higher speed than the method of inclining the electronic optical system of the SEM and has a little restriction of the inclination angle, so that it can realize almost the same inclination angle as the method of mechanically inclining the electronic optical system. Nevertheless, it takes about several tens of seconds to incline the stage. Additionally, since the position of the image to be taken changes by inclining the stage, it is difficult to observe the same position where the inclination angles are different. Furthermore, the mechanism of inclining the stage is rather complex and consequently the weight of the stage is increased and a response to movement of the stage becomes poor.

Also, in the review SEM, there is generally used an ADR function of taking continuously and automatically the SEM images having the defects detected by the examination apparatus. However, the poor response of the stage causes an ADR throughput, which is the basic performance of the ADR, to deteriorate.

Additionally, in both methods about the conventional technique, when the inclined images are automatically taken, there is the further problem that it is impossible to automatically determine from which direction the inclined images are taken. In automatically taking the inclined images, in order to take the images of defects adhering to a pattern portion of a semiconductor pattern having a three-dimensional structure, it is necessary to decide directions of the inclined observation so that the defects are not in dead spaces of the semiconductor pattern having the three-dimensional structure. However, examinations of such a determining method have not yet known and the review method of automatically determining the direction of the inclined observation and automatically taking the inclined review images has not yet been realized.

The present invention provides a defect observing technique capable of determining automatically the direction of the inclined observation and taking automatically the inclined review images.

According to the invention, there is provided a method of observing defects comprising the steps of: irradiating a convergent electron beam to the defects to be observed, detecting an electron emitted from surfaces of the defects to be observed, and acquiring a planar image; displaying, on a display screen, a position for taking an inclined image, using ADC data from the acquired planar image; and deciding an inclination angle and direction per defect to be selected and observed, irradiating the convergent electron beam to the defects to be observed, detecting an electron emitted from each surface of the defects to be observed, and acquiring an inclined image.

More specifically, in a step of irradiating a convergent electron beam to the defects to be observed, detecting an electron emitted from surfaces of the defects to be observed, and acquiring a planar image, the inclined image-taking direction is automatically decided from the images of the detected electrons and an inclined review image is automatically taken. The direction in which the convergent electron beam is irradiated may be controlled with respect to the defects to be observed by deflecting the convergent electron beam relative to the decided direction through an electron beam deflector so as to displace them from an optical axis. Additionally, the electron emitted from each surface of the defects to be observed is detected by a secondary electron detector and a back-scattered electron detector simultaneously in order to be able to quickly shift the inclined image-taking direction and implement each three-dimensional profile of the defects to be observed.

Thus, according to the invention, it is possible to automatically decide the direction of inclined observation and take (pick up) the inclined review image so that the inclined images can be taken automatically on a batch processing with the minimal efforts.

These and other objects, features and advantages of the invention will be apparent from the following more particular description of preferred embodiments of the invention, as illustrated in the accompanying drawings.

### BRIEF DESCRIPTION OF THE DRAWINGS

FIG. 1 is a block diagram showing a defect observation system of an embodiment for implementing a defect observing method according to the present invention.

FIG. 2A is an explanatory view for showing an example of a wiring pattern of a defect to be observed in a defect observing system according to an embodiment of the present invention.

FIG. 2B is an explanatory view for showing an example of a wiring pattern of a defect to be observed in a defect observing system according to an embodiment of the present invention.

FIG. 3 is an explanatory view for showing an example of an incident angle of an electron beam to a wiring pattern of a defect to be observed in a defect observing system according to an embodiment of the present invention.

FIG. 4 is an explanatory view for showing an example of a contact hole of a defect to be observed in a defect observing system according to an embodiment of the present invention.

FIG. 5 is a flow chart showing a sequence of a defect observing method in a defect observing system according to an embodiment or the present invention.

FIG. 6A is an explanatory view for showing an example of a GUI that displays a planar image of a defect to be observed in a defect observing system according to an embodiment of the present invention.

FIG. 6B is an explanatory view for showing an example of a GUI that displays a planar image of a defect to be observed in a defect observing system according to an embodiment of the present invention.

FIG. 7A is an explanatory view for showing an example of a GUI that displays an inclined image of a defect to be observed in a defect observing system according to an embodiment of the present invention.

FIG. 7B is an explanatory view for showing an example of a GUI that displays an inclined image of a defect to be observed in a defect observing system according to an embodiment of the present invention.

FIG. 8A is an explanatory view for showing an exemplar of a GUI that simultaneously displays a planar image and a plurality of inclined images of defects to be observed in a defect observing system according to an embodiment of the present invention.

FIG. 8B is an explanatory view for showing an exemplar of a GUI that simultaneously displays a planar image and a plurality of inclined images of defects to be observed in a defect observing system according to an embodiment of the present invention.

FIG. 8C is an explanatory view for showing an exemplar of a GUI that simultaneously displays a planar image and a plurality of inclined images of defects to be observed in a defect observing system according to an embodiment of the present invention.

FIG. 9 is a block diagram showing a defect observing system of another embodiment for implementing a defect observing method according to the present invention.

FIG. 10A is an explanatory view for showing an example of a scratch of a defect to be observed in a defect observing system according to another embodiment of the present invention.

FIG. 10B is an explanatory view for showing an example of a scratch of a defect to be observed in a defect observing system according to another embodiment of the present invention.

### DESCRIPTION OF THE PREFERRED EMBODIMENTS

Hereinafter, embodiments of the present invention will be detailed based on the accompanying drawings. Note that members having the same function are denoted by the same reference numeral throughout all the drawings for describing the embodiments and the repetitive explanation thereof will not be omitted.

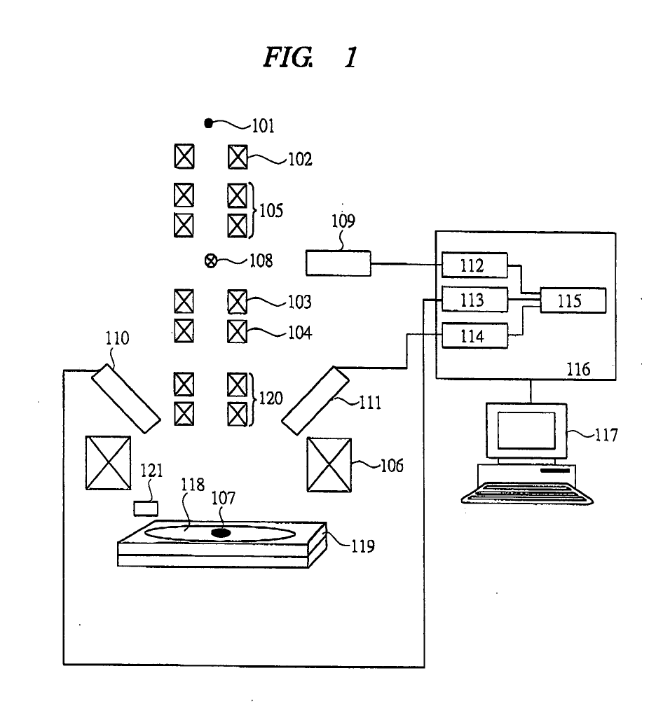

First, an example of a defect observing system for implementing a defect observing method according to the present invention will be described with reference to FIG. 1. FIG. 1 is a block diagram of a defect observing system of the present embodiment.

With the illustrated defect observing system, electron beams are irradiated from an electron-beam source 101 and the irradiated electron beams are made to pass through a condenser lens 102 and subsequently deflected by scanning units 103 and 104 so as to control the spot to be irradiated by the electron beams. Deflection units 105 and 120 control irradiation angles of the electron beams to an object. Then, the electron beams are converged by an objective lens 106 and irradiated onto a defect 107 occurring on a wafer 118 with an angle ζ.

Then, as a result, the defect 107 emits secondary electrons and back-scattered electrons. The secondary electrons are deflected by a Wien filter 108 and detected by a secondary electron detector 109. In contrast, the back-scattered electrons are detected by back-scattered electron detectors 110 and 111. The back-scattered electron detectors 110 and 111 are arranged in different directions, preferably arranged to have a point-symmetrical relationship relative to the irradiation spots of the electron beams.

Additionally, the secondary electrons and the back-scattered electrons detected respectively by the secondary electron detector 109 and the back-scattered electron detectors 110 and 111 are converted into digital signals by A/D converters 112, 113, and 114 and stored in a memory 115. The A/D converters 112, 113, and 114 and the memory 115 are provided in a computer system 116.

The computer system 116 is additionally provided with a GUI 117 for displaying images to a user. The GUI 117 displays simultaneously the secondary-electron image stored in the memory 115 and the back-scattered-electron image stored therein and taken from different directions, or displays any of those images selected by the user. With the above-described arrangement, the user can observe the secondary electron image and the two back-scattered-electron images that are taken aslant, by irradiating the electron beams inclined (slanted) from vertically to the defect 107 of the object. The two inclined back-scattered-electron images taken aslant from two different directions each have an easily observable inclined portion in comparison with a conventional image obtained by irradiating electron beams from vertically.

Also, the wafer 118 is mounted on an XY stage 119, whereby the wafer 118 is moved and the images at any positions of the wafer 118 can be taken. The system is further provided with an optical height displacement meter 121, and the setting of the objective lens 106 is changed based on the height measured by the height displacement meter 121 so as to minimize the beam diameter of each electron beam at the defect 107.

Although FIG. 1 shows an arrangement of providing two back-scattered electron detectors, the number of back-scattered electron detectors may be more than or less than two. If three back-scattered electron detectors are provided, it is possible to find a gradient of the object in greater detail. When a single detector for the back-scattered electron images is provided, the gradient of the object surface at the irradiated spot of the electron beams cannot be found qualitatively. However, it is possible to extrapolate the surface gradient of the object by analyzing lightness distribution of the two-dimensional back-scattered electron image.

In the back-scattered-electron images, the intensity of the detected back-scattered electrons is determined by a relation among solid state properties of the object, detected directions of the back-scattered electrons by the detector, and a normal direction of the surface of the object irradiated by the electron beams. Therefore, if a region constituted by the same material can be extrapolated, a gradient of the surface of the object can be extrapolated based on intensity distribution of the back-scattered electrons within the region, so that it is extremely easy to extrapolate the profile in comparison with the secondary electron images. Meanwhile, the secondary electron detector can be used effectively to observe to what extent the defect in a contact hole is embedded in the hole or a wall of the contact hole is completed.

In a process of manufacturing semiconductor products, to which the present invention is applied, a pattern of multilayer structure is formed on a semiconductor wafer through a large number of steps. In the manufacturing process of such a multilayer structure, an appearance examination per layer is conducted in order to monitor the manufacturing process, and review of the defects detected by the appearance examinations is made, and classification per kind of defects is made. As a method of reviewing the detects, there are generally proposed and used some methods such as: (1) a technique for reviewing the images taken by the examination apparatus during examination; (2) a revisiting type technique for again taken the images of the defects by using appearance imaging equipment of the examination apparatus; and (3) a technique for reviewing the images by using a review apparatus such as the review SEM separated from the examination apparatus.

Now, a sequence of a type of item (3) will be described in greater detail. After conducting the appearance examination, an object having the appearance at the coordinate on the wafer of the defects detected from the examination object is again taken by the review apparatus and acquired. Then, the user classifies the image into defect categories such as a foreign substance, a pattern defect, and a scratch by the manual, and analyzes the number of defects in each defect category, distribution of defective sizes, and distribution of defective spots having occurred on the wafer, thereby finding out problems of the manufacturing process.

By a semiconductor manufacturing process in recent years, semiconductors have been increasingly miniaturized, so that many defects occur when the manufacturing process is deviated only slightly from an optimal condition. Thus, when a new process is adapted to miniaturize the semiconductors, it is required to take inclined images of the defects for the purpose of extrapolating the cause of each defect.

In the SEMs having already been known until today, as a method of taking inclined images using the SEM, for example, as a method of inclining and observing objects of the SEM, there are applied: (A) a method of deflecting the electron beam irradiated from the electronic optical system and inclining irradiation directions of the electron beam to take the inclined images (for example, Japanese Patent Laid-open No. 2000-348658); (B) a method of inclining a stage per se for moving a wafer so as to observe any locations on the wafer by the SEM; and (C) a method of inclining mechanically the electronic optical system itself.

However, as pointed out earlier, item (A) has the restriction that the inclined angle is changed only to about ±10 degrees, so that it is not suitable for the inclined observation of the defects. In items (B) and (C), the time necessary for switching the inclination angle is too long and hence they are not suitable for mass production lines that require observing a large number of defects within a short period of time. Also, the ADR for automatically taking the images of defects based on coordinate information on the defects detected by the examination apparatus has been widely used for observing the defects in the mass production lines. However, it has been difficult to be compatible with the inclined observation and the ADR by using all of items (A), (B) and (C).

The pattern formed on the semiconductor wafer has a three-dimensional profile. Therefore, when the defects are observed from the inclined directions, they can be shadowed by the pattern and the inclined images of the defect that needs attention cannot be detected sometimes. Generally, in order to acquire the good inclined images of the defect, it is desirable to grasp the three-dimensional profile of the pattern and the locations of the defects and thereafter take the inclined images of the defect from directions good for observing the defect. However, these have not been achieved by the conventional techniques and consequently all the inclined observation of the defects is manually conducted.

Thus, in the present invention, there is found out an inclined observation method of combining the beam deflecting technique as described in item (A) and a technique for detecting a back-scattered electron beam image and clearing the three-dimensional characteristics of the object even when the beam deflecting angle is limited to about ±10 degrees, in order to solve the above-identified problem.

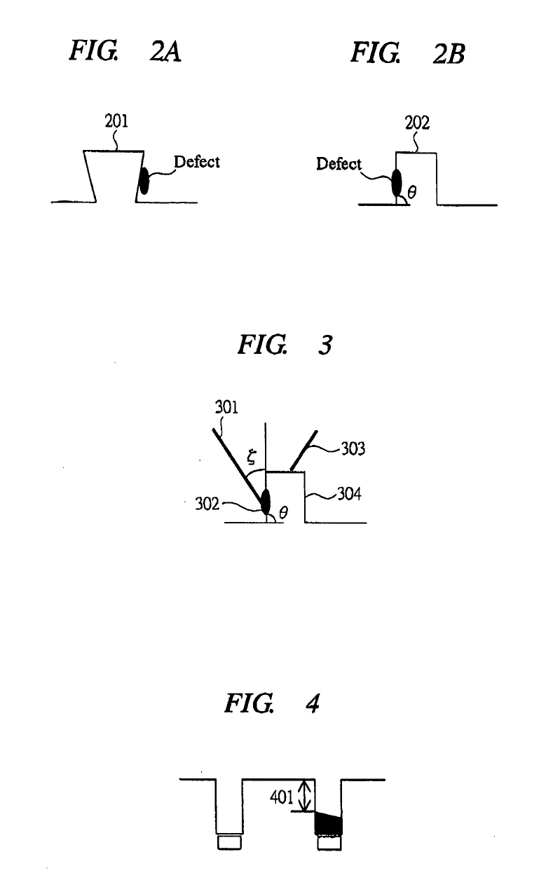

For example, Japanese Patent Laid-Open No. 2003-28811 discloses a method of clearing three-dimensional characteristics of an object of observation by using the back-scattered electrons, wherein the electron beams are irradiated from right above the observation object, that is, from a so-called top-down direction and the back-scattered electrons are detected from directions different from each other and three-dimensional information on the object of observation may be cleared based on to the differences among the back-scattered electrons. However, in such a method, when a wire 201 is inversely tapered as shown in FIG. 2A, it is not possible to review any defect of an edge section of an inversely tapered wire because the electron beams are irradiated from the top-down direction.

In the case of a wire that is not inversely tapered, if the angle δ between the wafer surface and the inclined surface of the object to be observed is large as shown in FIG. 2B, an area of an image to be taken in the inclined images on the surface of the observation objects is proportional to cos θ and therefore is small. Accordingly, it is difficult to clear the surface of the defect to be an observation object. On the other hand, if the electron beam 301 is deflected by an angle ζ and is incident as shown in FIG. 3, the area of the image to be taken is increased together with cos (θ·ζ) and has the same effect as that of substantially improving horizontal resolution of the inclined surface, and so it is easy to clear the inclined surface.

Furthermore, the present invention operates effectively for observing, by the secondary electron detector, to what extent the defect in the contact hole is embedded in the hole or a wall of the hole is formed. FIG. 4 shows the contact hole.

As shown in FIG. 4, generally, after forming the contact hole, a conductive material is buried in it so as to electrically connect a lower layer and an upper layer. If any patterns and/or foreign substances are found on a bottom of the hole, the conductive material does not reach the lower layer, which leads to a fatal defect. To analyze the cause of such a defect, it is effective to observe the wall of the hole in which the defect exists and to observe to what extent the hole is buried by such substances. If the hole is completely filled with such foreign substances, it is extrapolated that there is large pattern destruction in the lower layer. On the other hand, if the hole substantially reaches the lower layer, it is extrapolated that the defect is attributable to smaller foreign substances. These can be judged by comparing the length 401 of each wall of the holes to be observed.

It is difficult to observe such defects using the back-scattered electron image. The sensitivity of detection of the back-scattered electrons is greatly affected by a direction in which the back-scattered electrons are emitted from the object of observation and electrons other than those that are reflected toward the back-scattered electron detector can hardly be detected. Since the back-scattered electrons coming from the inside of the hole and directed toward the back-scattered electron detector are intercepted by the wall of the hole, they cannot be detected by any back-scattered electron detectors if they are directed to different directions.

On the other hand, since the secondary electrons have no directional properties unlike back-scattered electrons, it is easy to detect the defect in the hole by the secondary electrons. Since the secondary electrons have such properties, secondary electron images are used for observing the wall of the hole. The generation efficiency of the secondary electron is generally expressed by 1/cos (θ·ζ) (ζ: incident angle of electron beam and θ: angle of surface inclination of object). If the incident angle ζ is not changed, θ·ζ is close to 0 degree at the wall of a hole so that a very light image is obtained for the wall and the lightness will be saturated on the obtained image. Then, no information may be acquired from the image. However, saturation of lightness is avoided to make it possible to observe the wall of the hole by changing ζ to an angle of about 10 degrees.

The above discussion leads to the following conclusions.

(1) In order to inline the electron beams and observe the inclined images, since the observation by the back-scattered electron images is generally desired, it is necessary to have the back-scattered electron detector as an electron detecting system.

(2) It is desirable to provide two or more back-scattered electron detectors and detect the back-scattered electrons from simultaneously different angles because it is impossible to qualitatively determine the slope of the object of observation at the spot of the electron beam irradiation by a single back-scattered electron detector even if the electron beams are inclined for irradiation.

(3) In the object such as the defect in the hole, the secondary electron detector needs to be provided to detect the secondary electrons besides the back-scattered electrons because it is necessary to observe the wall surface of the hole by the secondary electron image.

It has already been described that the back-scattered electrons by the defect observing system as illustrated in FIG. 1 has one purpose for making it possible to observe the defect with a small inclination angle of the electron beams. In addition thereto, the back-scattered electrons are effective for automatically taking the images of the defects for inclined observation. Referring back to FIG. 3, if the defect 302 is inclined like the electron beam 301, the defective slope can be observed with higher resolution. Meanwhile, the defect is shadowed by the wire 304 and can no longer be observed when the incident electron beams 303 are inclined.

In this case, in the conventional inclined observation, the spot at which the detected defect occurs is manually observed, and, after checking a state of the pattern adjacent thereto, the inclined observation direction in which the defect is made most visible is determined. Note that, as the above-described techniques for taking the inclined images, items (B) and (C) cannot be used to automatically determine an inclined observation direction other than that of item (A) of inclining the incident direction of the electron beams.

However, it has been required in recent years to improve the efficiency of the defect observation in semiconductor plants and a technique of automatic defect review is widely used when observing the object by causing the electron beams to strike the object along the normal of the wafer together with the technique of automatically taking the images of many defects outputted from the examination apparatus on the basis of the coordinates of the defects that are also outputted from the examination apparatus by the ADR. Furthermore, when the electron beams are made to strike the object from the inclined directions, it is required to automatically take the images of many defects for inclined observation in order to improve the efficiency of the defect observation.

Therefore, in the present invention, the inventors have found out a technique for automatically determining inclined directions from which an image of a defect can be taken automatically and effectively. The region of the defect is automatically detected and then the direction that can implement the positional correspondence of the pattern and the defect spot, that is, the defect region that requires attention, is computationally determined. First, the image of the defect is taken without inclining electron beams and the defect region is extracted. The method disclosed in Japanese Patent Laid-Open No. 2003-28811 may appropriately be used to extract the defect region.

Then, the positional relationship between the detected defect and a neighboring wire is computed by the secondary electron image or back-scattered electron images. As one of the techniques that can be used for this purpose, the image of the detected defect is subjected to a differential processing so as to determine the direction of the wire. Generally, it is desirable to incline the electron beams that irradiate the defect to a direction perpendicular to a sidewall of the wire for the purpose of implementing the positional relationship between the wiring pattern and the defect. An image taken in this way provides the advantage that the resolution of the sidewall of the wire is maximized on the obtained image, although it also gives rise to the problem of producing a large dead angle because the wire blocks the visual field. However, when obtaining the inclined image by inclining the incident angle of the electron beams, the use of this technique is particularly desirable because the incident angle that can be taken is small and hence the dead angle can hardly occur.

After subjecting the image of the detected defect to a differential process, the direction of the edge of the wire near the defect is determined from the differential value of the defect and its vicinity so that the electron beams irradiating the defect are inclined to a direction perpendicular to the direction of the edge. While there are two directions that are perpendicular to the direction of the edge of the wire, the one that makes the defect less hidden by the dead angle is selected. While the region hidden by the dead angle will not change significantly if either direction is used when the defect is large, the defect can completely reach the dead angle and it may be impossible to take the image of the defect if the wrong direction is selected when the defect is small.

A technique of preventing the defect from going into the dead angle of the wiring pattern is to exploit a property of the back-scattered electron image. In the back-scattered electron image, a region where the wire blocks the back-scattered electrons is dark. A region that is detected as a light region in the two back-scattered electron images is found on a wiring pattern or underlying portion. No edge is found other than that of the defect in the region on and near the underlying portion that are remote from the wire. Therefore, the edge that is found light in the tow back-scattered electron images is recognized as a wire. The wire located closest to the defect can produce a dead angle when taking the image of the defect. Thus, it is advisable to take the image of the defect by inclining the electron beams to a direction opposite to the wire located closest to the defect.

A computer system 116 is made to execute the above-described image recognition processing to automatically determine the inclined observation direction. It is also possible to use a technique for determining the inclined observation direction by using CAD information instead of the image recognition processing. The throughput can be raised by using the CAD information because it is not necessary to take the images in order to determine the inclined observation direction.

While the inclined observation direction of the defect can be determined automatically at a time of taking the image of the defect for inclined observation according to the invention, it may not always be necessary to observe every defect by the inclined observation. While the defect observing system illustrated in FIG. 1 can take the back-scattered electron images of any defects for the defect observation, the defects that require the inclined observation may be only part of all the detected defects and it is time consuming to compute the inclination angle and switch the inclination angle by hardware for inclined observation, so that the throughput will inevitably be reduced if all the defects are subjected to the inclined observation.

Therefore, there may be the cases where the defects that require the inclined observation are sorted in advance. With one of the techniques that can be used for such preliminary sorting, the user specifies the defects that are to be subjected to the inclined observation. With this technique, the images of the defects are automatically taken in advance by the ADR without inclining the electron beams or by inclining the thrust bearings to a predetermined direction and then the taken defect images are displayed by the GUI 117 shown in FIG. 1. Then, the user selects the defects requiring the inclined observation out of the displayed defect images, and executes the ADR for inclined observation. Then, the defect observing system takes the image of each defect from the direction automatically determined for it by the above-described technique.

Note that, in the ADR for inclined observation, the coordinates of the defect, which is detected by the ADR used before the ADR for inclined observation, are utilized instead of the coordinates of the defects outputted from the examination apparatus so as to make it possible to put the defect into the visual field without fail. At this time, it is desirable to concurrently display the defect distribution of the wafer and the coordinates of each of the defects on the wafer by the GUI 117.

The defects on the semiconductor wafer are grouped according to a inter-defect distance and a defect density on the basis of the defect distribution of the semiconductor wafer. Each defect group is then referred to as a “cluster” or “region” and indicates that a manufacturing process is not regulated properly. When the defects are generated due to scars etc., the causes of the defects are found on the manufacturing line. It has been known that the scratches easily occurring in a CMP step show an arced profile. The defects occurring randomly are poorly correlated to the manufacturing process and caused by foreign subjects in many cases.

Generally, an amount of information obtained by the inclined observation is small with respect to the foreign subjects occurring randomly and, therefore. This is because it is required to make the inclined observation about correlation with regulated conditions of the manufacturing process. Even regarding the defects displayed on a wafer map, as a result of the examination conducted in the preceding steps on the basis of the coordinates of the defects, it is desirable that the defects having already occurred at the same spots are emphasized on the display screen for implementation.

This is because it is thought that the defects occurring in the preceding steps give rise to defects at the current step and, by the observation of the inclined images, it is easy to make an analysis of what mechanism causes this phenomenon. A method disclosed in Japanese Patent Laid-Open No. 2002-57195 can be applied to such an analysis. Further, in executing the ADR, it is desirable to sort the detected defects into categories at the same time and identify the defects of different categories by coloring them on the wafer map being displayed on the display screen according to the result of the categories.

The defects having merits by conducting the inclined observation are roughly known in each step. Defective burial at a wiring section using a copper wiring, debris adhering to a sidewall of a wiring in the gate step and/or metal step, and a hole-bottom defect occurring in a contact hole (particularly those extending to a plurality of holes) are examples of such defects. Such defects can be sorted by the ADR and it is effective to sort out defects to be observed by the inclined observation. The method described in Japanese Patent Laid-Open No. 2001-135692 can be used for a ADR sorting method.

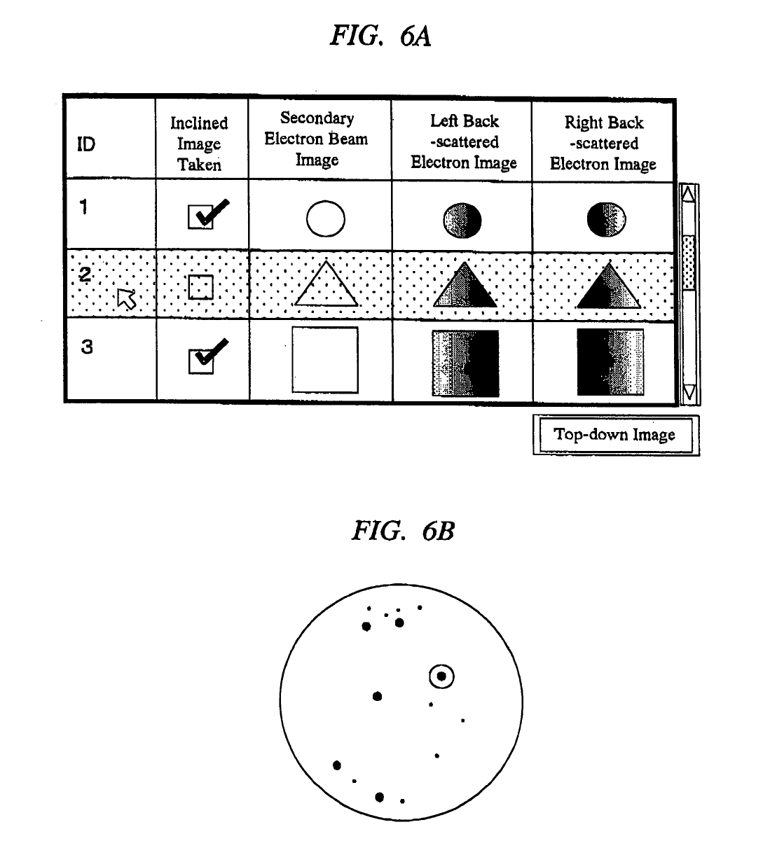

FIGS. 6A and 6B show an example of a GUI for displaying a planar image of a defect to the user. FIG. 6A shows a secondary electron image and two back-scattered electron images (left and right) of the defect in a table. Slots at which the respective defects are detected on the wafer are plotted, wherein the ADR is executed by the review SEM and the images displayed in the table are indicated by relatively large spots. As the user clicks the spots on the table by a pointer, the corresponding spot is emphasized in the corresponding wafer map as shown in FIG. 6B. The table is provided with a check box for instructing the user about whether the inclined images of the defect are taken.

Another method is one of automatically determining images for inclined observation. As pointed out above, certain criteria for selecting the defects to be aslant observed are roughly known in advance. The criteria are defined as rules and the defect observation system is provided with the rules so that it is possible to automatically observe the defects without specifying the defects by the user. As a method of automatically finding an advantageous pattern from a defect distribution of a wafer map, for example, Japanese Patent Laid-Open No. 2003-59984 has been known and can be applied to the present invention.

A method of defining the defects to be observed for inclined observation and a method of deciding an inclination angle may be used not only for the method of deflecting the irradiation angle of the electron beam in item (A) but also for the method of inclining the stage in item (B) and the method of mechanically inclining the electronic optical system in item (C). However, even if any of the methods is applied, it takes time to change the inclined directions from which the defect is observed and, particularly, it is known in items (B) and (C) that it takes long time to change such directions. Therefore, in order to achieve a high throughput, it is desirable to change the inclined directions as small as possible.

Thus, when the inclined observation direction is found out in an ADR to be executed before the ADR for inclined observation is executed, inclines from the same direction are summed up and order of images taken is automatically optimized. Generally, semiconductor patterns are arranged horizontally or vertically in many cases, preferably in two directions at minimum, and it is more preferable to select any one of inclined observation directions from four directions. By optimizing the order of the images to be taken, it is preferable to switch as many inclined directions as the inclined observation directions automatically determined, whereby it is possible to reduce a switching time.

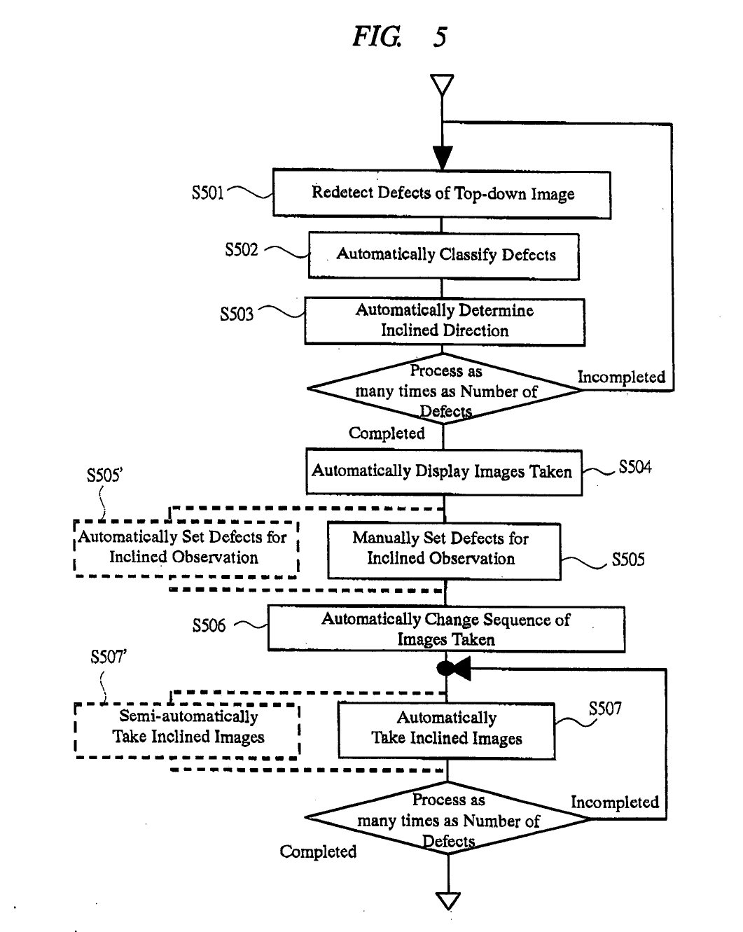

FIG. 5 is a flow chart illustrating the above-described sequence. FIG. 5 shows a method of performing an ADR to many defects and then specifying defects aslant observed by the user among the above-mentioned methods. That is, the positions for taking the inclined images are automatically displayed on the a display screen from the plane images (top-down images) of the SEM by using data of the ADC, and the defects specified by an operator (herein user) are selected from the images displayed on the display screen, and the inclined angle and direction are determined per selected defect to take the inclined images (beam tilt images), and the inclined images of the defect are obtained.

In Step S501, a defect is redetected by a defective image using an image obtained without switching the inclined angle (generally by an image having no inclined angle, i.e., a top-down image). Generally, the defect is redetected, by comparing an image of the defect taken in such a way that the coordinates of the defect outputted from the examination apparatus come into the visual field of the SEM, and a reference image that has the same pattern as the image of the defect and is an image having no defect. As a method of redetecting a defect, various methods have been proposed and for example, a method as disclosed in Japanese Patent Laid-Open No. 2000-30652 can be applied.

In Step S502, an image processing is performed to the detected image and the defects are automatically classified. In Step S503, the direction from the inclined image to be taken is automatically determined by using: a position of the redetected defect; a defect image taken; a reference image; or CAD data. A sequence from Steps S501 to S503 is repeated as many times as the number of specified defects and then, in Step S504, the image is automatically displayed to the user so as to prompt the user to specify the defects for inclined observation in Step S505. Then, in Step S506, the specified defects are classified into groups according to the direction of specifying the defects for inclined images and the defect imaging sequence is automatically changed. Then, in Step S507, the inclined images are automatically taken according to the sequence.

If the precision of the stage is not sufficient, it will be necessary to detect the defects from the inclined images once again. With a technique that can be used for this purpose, a reference inclined image and a defect image are taken with a relatively low magnification and the position of the defect is detected by comparing the images. Then, the defect is imaged with a raised magnification in such a way that the detected defect is centered in the taken image. With another technique that can be used for this purpose, an image of the defect is taken with the same magnification as that of Step S501 and subjected to a pattern matching operation with the image taken in Step S501 and the defect is imaged once again at the position of the defect region detected in Step S501. This technique provides an advantage that the inclined image is obtained for the image selected by the user because it is necessary for the inclined observation.

When the defect is large or when a number of defects exist in a single visual field, it is not clear if an image of the same spot is obtained once again when the defect is detected independently from the inclined images. However, with the above described latter technique, the image of the defect is subjected to a pattern matching operation with the image detected in Step S501, so that it is necessary to taken the top-down image once again and hence switch the inclined direction twice as many times as the number of defects. Then, the throughput will be reduced inevitably. On the other hand, it is difficult to use the items (B) and (C) that respectively mechanically operate the stage and the electronic optical system with the above described latter technique because the mechanical precision, the response of the stage, and that of the electronic optical system are not sufficient.

When the item (A) is used, it is possible to subject images of different inclination angles to a pattern matching operation because the angle of deflection of the irradiated electron beams is small for one thing. Then, the image detected in Step S501 and the inclined image taken from the automatically computed inclined direction are subjected to the matching operation to locate the position of the defect. This arrangement does not reduce the throughput because it is not necessary to switch the inclined direction.

A process where the user specifies the defects that require the inclined observation is described above by referring to the flow chart of FIG. 5. However, it may alternatively be arranged so that the system automatically specifies the defects as described earlier. If such is the case, the defects that require the inclined observation are specified automatically in Step S505′ indicated by broken lines in FIG. 5 and the defect imaging sequence is automatically changed to allow the inclined images to be automatically taken.

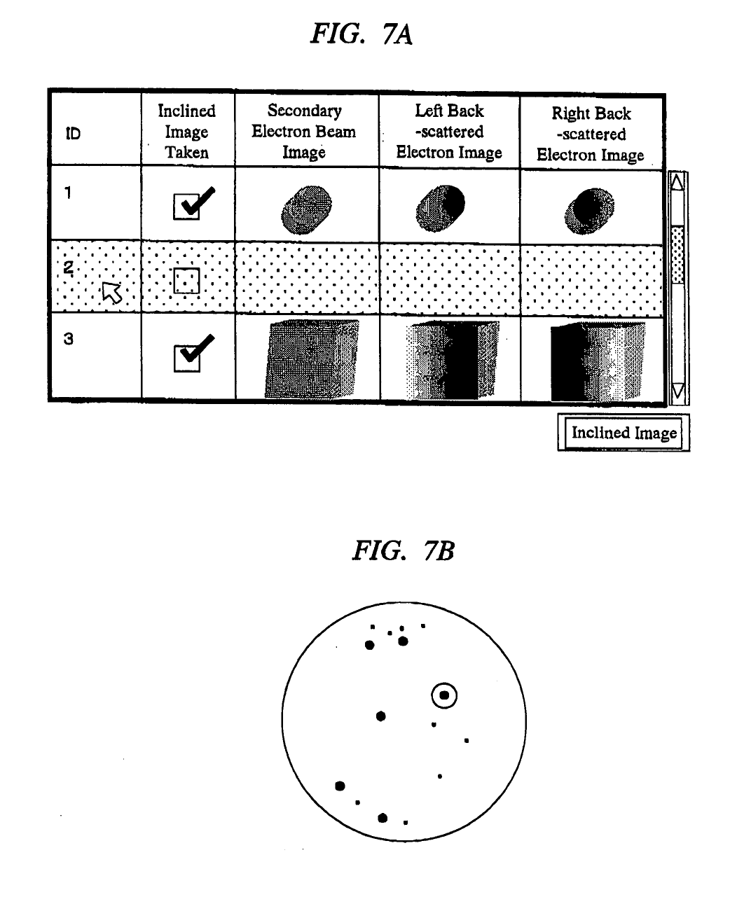

A synoptic collection of inclined images that are taken in this way are displayed as secondary electron images and left and right back-scattered electron images as shown in FIGS. 7A and 7B when the user clicks the check boxes for taking inclined images at ID=1 and ID=3 as shown in FIG. 6A. Then, the user prints necessary images by means of a printer and/or transfers them to a computer for storing the defect image connected to a network.

Techniques for automatically taking a group of inclined images are described so far. However, it is also possible to semi-automatically take the inclined images for observation of one-by-one defect by using the arrangement of the present invention (Step S507′ indicated by broken lines in FIG. 5). When the inclined image is taken by deflecting the irradiation angle of the electron beams as shown in FIG. 1, the time necessary for changing the inclined direction is relatively short in comparison with the other techniques and, unlike the other techniques, neither the stage nor electronic optical system needs to be mechanically moved so that it is possible to take the inclined images of the same defect from the different directions with high accuracy.

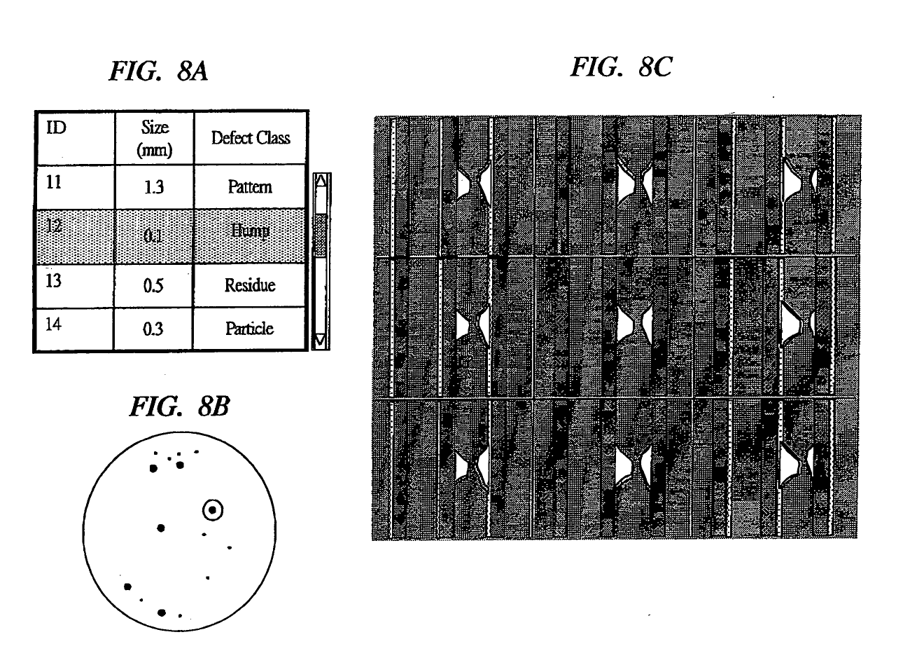

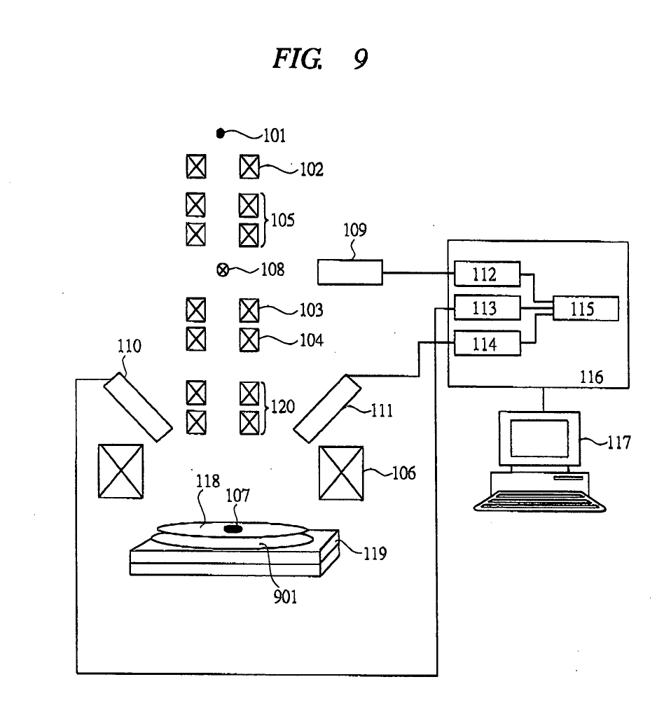

Accordingly, the inclined images from a plurality of directions are sequentially taken and concurrently displayed. The images to be displayed are shown in FIGS. 8A, 8B, and 8C. More specifically, FIG. 8A shows a list of defects to be reviewed that are inputted from the examination apparatus and shows IDs of the defects along with size and class of each defect as evaluated by the examination apparatus or a review apparatus. FIG. 8B shows a wafer map illustrating a distribution of defects on the wafer, in which the defects detected on the wafer are shown as spots. Of the spots, the large ones indicate the same spots at which the defects exist also in the preceding step. By a mouse or some other pointing devices with which the review apparatus is provide, the user can give an instruction of which inclined images of the defects are to be taken.

The inclined images are taken sequentially from eight directions different from one another per 45 degrees, and nine images out of the top-down images each having no slant together with the eight inclined images are displayed on the display screen simultaneously. They are displayed as the inclined images with respect to the defect and indicated as shown in FIG. 8C to the user (an example of a hump (defect in which an unnecessary pattern is protrude from a wiring pattern)). The top-down image is arranged at the center of the eight inclined images that are taken from the eight directions different per 45 degrees.

Particularly, in the method of inclining the irradiation direction of the electron beams when the inclined image is observed, the inclination angle is limited. Therefore, there is the problem that it is difficult for the user to judge the defects on the display screen. For this reason, it is required to compute images each having further inclined angle and display them to the user. This is found out from the image computed by the three-dimensional shape of an image to be taken at a certain position and thereby obtained by mapping a texture to the computed image. To compute the three-dimensional shape thereof, an inverse stereo-matching technique proposed by Makoto Kazui, “Estimation of the Cross-Sectional Profile of LSI Wiring by Inverse Stereo-Matching”, Collection of Reports of the 8th Symposium on Sensing via Image Information, pp. 291-294 can be also used. However, it is difficult to reconfigure a proper three-dimensional image simply by applying this technique.

This reason is as follows. In the case of the SEM image, in a region where a profile is modestly changed and no edge effect occurs, such a change in lightness as to be corresponding points of the stereo does not appear, so that it is difficult to compute height of the image by the stereo. To solve it, using a photometric stereo by the back-scattered electron image together with the above-mentioned stereo is effective. Such a technique is, for example, S. Serulnik, “Defect Topographic Maps Using a Non-Lambertian Photometric Stereo Method”, Proceedings of SPIE Vol. #4692, Design, Process, Integration, and Characterization (2002), or the like.

In the case of the photometric stereo, it is possible to determine a gradient of the object at each pixel thereof by using the back-scattered electron images, but it is impossible to determine the height of a step-shaped bump. In the case of the stereo, on the other hand, it is possible to compute the height of the step because the edge can be implemented. However, it is impossible to expect the performance thereof at a mild gradient. Therefore, by computing the height of the step-shaped portion by the stereo and then interpolating the height of the modestly inclined portion using the gradient obtained from the photometric stereo, the three-dimensional profile can be computed satisfactorily.

It is possible to extrapolate the profile of a defective part by performing a texture mapping processing to the obtained three-dimensional profile more easily than simply observing the image obtained by a detection system as it is. By applying this technique, even if the electron beams each having maximally an inclination angle of about 15 degrees are changed to about 30 degrees for image conversion, no large disturbances occurs to the resolution of the obtained images.

Then, a technique of obtaining the excellent inclined images by improving the detection system in the defect observing system of the present embodiment will be described below. In the structure of the electronic optical system shown in FIG. 1, the two back-scattered electron detectors mounted on the system cannot have sensitivity in a direction perpendicular to the direction to which each detector has sensitivity. Additionally, if the defect is located between wirings showing a large aspect ratio, the back-scattered electrons are blocked by the wiring, so that it is difficult to obtain a good image of the defect. This problem can be solved also by increasing the number of back-scattered electron detectors. However, another solution of the problem is to fix the object of observation to the rotary stage and make the wafer rotatable so that the observation by the back-scattered electrons can be easily made. An embodiment of this case is shown in FIG. 9.

In FIG. 9, a wafer 118 is mounted on a rotary stage 901, and the rotary stage 901 is fixed to an XY stage 119. All the remaining components (101 through 120) are identical to the respective components as shown in FIG. 1.

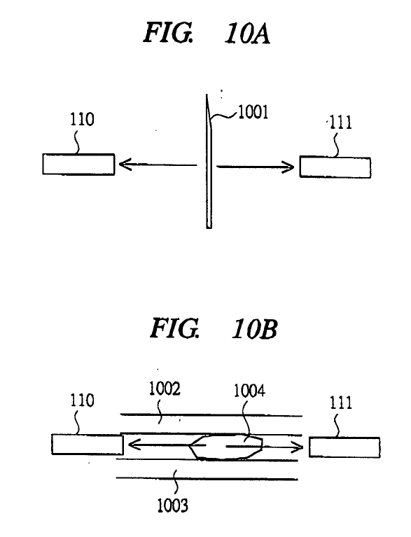

To implement the three-dimensional profile of a defect to be an object of observation by the defect observing system of FIG. 9, it is desirable to set a gradient of the object having the defect so as to be perpendicular to the directions in which the two back-scattered electron detectors each have sensitivity similarly to a scratch 1001 illustrated in FIG. 10A. To implement a profile of the defect occurring between the wirings having large aspect ratios, as shown in FIG. 10B, if the directions in which the back-scattered electron detectors each have sensitivity coincide with each direction of wirings 1002 and 1003, it is possible to make observation by the back-scattered electron beam also to an object 1004 interposed between the wirings. By adopting such arrangement, it is possible to obtain the further excellent inclined observation of the object.

Thus, according to the above-described embodiments, it is possible to improve the response of the defect observing system without any mechanical operation, by biasing the electron beams and controlling the angle in which the deflected electron beams are irradiated onto the wafer. Additionally, the defects of the inclined images to be taken can be automatically selected by: providing the back-scattered electron detector so as to implement the three-dimensional profile of the defect even when the deflection angle is small; automatically determining the directions of inclined observation using the defect images or CAD data to be acquired in advance; and using the defect distribution in the ADC or wafer map. As a result, it is possible to automatically take the inclined images by a batch processing through the minimal efforts.

The invention may be embodied in other specific forms without departing from the spirit or essential characteristics thereof. The present embodiment is therefore to be considered in all respects as illustrative and not restrictive, the scope of the invention being indicated by the appended claims rather than by the foregoing description and all changes which come within the meaning and range of equivalency of the claims are therefore intended to be embraced therein.

1. A method of observing defects, comprising:
a planar image acquisition step of irradiating a convergent electron beam to the defects to be observed, detecting an electron emitted from surfaces of said defects to be observed, and acquiring a planar image;
a selection step of displaying, on a display screen, a position for taking an inclined image, using ADC data from the planar image acquired through said planar image acquisition step; and
an inclined image acquisition step of deciding an inclination angle and direction per defect to be selected and observed by said selection step, irradiating the convergent electron beam to the defects to be observed, detecting an electron emitted from each surface of said defects to be observed, and acquiring an inclined image.

2. The method of observing defects according to claim 1,
wherein, in said planar image acquisition step or said inclined image acquisition step, the electron emitted from each surface of said defects to be observed is detected by a secondary electron detector and a back-scattered electron detector, intensity of a secondary electron detected by said secondary electron detector is imaged as a secondary electron image, and intensity of a back-scattered electron detected by said back-scattered electron detector is imaged as a back-scattered electron image.

3. The method of observing defects according to claim 1,
wherein, based on coordinate data of the defects detected through an examination of a specimen in which said defects to be observed occur, said planar image acquisition step regards a plurality of defects specified in advance as said defects to be observed and takes images of said plurality of defects,
said selection step displays a list of an image group of defects of images taken by said planar image acquisition step or a defect occurrence distribution map of the specimen in which said defects to be observed occur, and inputs specification of an imaged defect out of said defects, and
said inclined image acquisition step takes an image of a defect group specified by said selection step.

4. The method of observing defects according to claim 3,
wherein, after picking up images of said plurality of defects, said planar image acquisition step classifies performs an image processing to the picked-up images and classifies the defects based on attributes of said plurality of defects, and
said selection step displays a classification result of said defects with respect to the defect occurrence distribution map of the specimen in which said defects to be observed occur.

5. The method of observing defects according to claim 3,
wherein said selection step determines whether inclined images of said defects to be observed are automatically taken using a classification result of defects corresponding to said plurality of defects or a distribution of defects on the specimen in which said defects to be observed occurs.

6. The method of observing defects according to claim 1,
wherein said selection step performs a processing to the images taken in said planar image acquisition step and extracts a defect region, and further performs a processing to the images taken in said planar image acquisition step or determines automatically an image-taking direction of an inclined image based on CAD data.

7. The method of observing defects according to claim 3,
wherein said inclined image acquisition step deflects said convergent electron beam so as to deviate from an optical axis by an electron beam deflector, and controls an irradiation direction of said convergent electron beam with respect to said defects to be observed.

8. The method of observing defects according to claim 7,
wherein said inclined image acquisition step mechanically rotates the specimen in which said defects to be observed occurs, and regulates a relation between said defects to be observed and a sensitive directions for detecting the back-scattered electron to detect images.

9. The method of observing defects according to claim 1,
wherein said selection step sets a plurality of directions for irradiating said convergent electron beam with respect to said defects to be observed, and
said inclined image acquisition step takes images of said defects to be observed from a plurality of directions set by said selection step, and displays simultaneously the images taken from said plurality of directions.

10. The method of observing defects according to claim 2,
wherein said selection step sets a plurality of directions for irradiating said convergent electron beam with respect to said defects to be observed, and
said inclined image acquisition step takes images of said defects to be observed from said plurality of directions set by said selection step, computes three-dimensional surface profiles of said defects to be observed using a back-scattered electron image out of the images taken from said plurality of directions, and displays said computed three-dimensional surface profiles.

11. The method according to claim 2,
wherein, based on coordinate data of the defects detected through an examination of a specimen in which said defects to be observed occur, said planar image acquisition step regards a plurality of defects specified in advance as said defects to be observed and takes images of said plurality of defects,
said selection step displays a list of an image group of defects of images taken by said planar image acquisition step or a defect occurrence distribution map of the specimen in which said defects to be observed occur, and inputs specification of an imaged defect out of said defects, and
said inclined image acquisition step takes an image of a defect group specified by said selection step.

12. The method according to claim 11,
wherein, after picking up images of said plurality of defects, said planar image acquisition step classifies performs an image processing to the picked-up images and classifies the defects based on attributes of said plurality of defects, and
said selection step displays a classification result of said defects with respect to the defect occurrence distribution map of the specimen in which said defects to be observed occur.

13. The method according to claim 11,
wherein said selection step determines whether inclined images of said defects to be observed are automatically taken using a classification result of defects corresponding to said plurality of defects or a distribution of defects on the specimen in which said defects to be observed occurs.

14. The method according to claim 2,
wherein said selection step performs a processing to the images taken in said planar image acquisition step and extracts a defect region, and further performs a processing to the images taken in said planar image acquisition step or determines automatically an image-taking direction of an inclined image based on CAD data.

15. The method according to claim 2,
wherein said selection step sets a plurality of directions for irradiating said convergent electron beam with respect to said defects to be observed, and
said inclined image acquisition step takes images of said defects to be observed from a plurality of directions set by said selection step, and displays simultaneously the images taken from said plurality of directions.

16. A method of observing defects, comprising:
a planar image acquisition step of irradiating a convergent electron beam to the defects to be observed, detecting an electron emitted from surfaces of said defects to be observed, and acquiring a planar image;
a selection step of displaying, on a display screen, a position for taking an inclined image from the planar image acquired through said planar image acquisition step; and
an inclined image acquisition step of deciding an inclination angle and direction per defect to be selected and observed by said selection step, irradiating the convergent electron beam to the defects to be observed, detecting an electron emitted from each surface of said defects to be observed, and acquiring an inclined image.

17. The method according to claim 16,
wherein, in said planar image acquisition step or said inclined image acquisition step, the electron emitted from each surface of said defects to be observed is detected by a secondary electron detector and a back-scattered electron detector, intensity of a secondary electron detected by said secondary electron detector is imaged as a secondary electron image, and intensity of a back-scattered electron detected by said back-scattered electron detector is imaged as a back-scattered electron image.

18. The method according to claim 16,
wherein, based on coordinate data of the defects detected through an examination of a specimen in which said defects to be observed occur, said planar image acquisition step regards a plurality of defects specified in advance as said defects to be observed and takes images of said plurality of defects,
said selection step displays a list of an image group of defects of images taken by said planar image acquisition step or a defect occurrence distribution map of the specimen in which said defects to be observed occur, and inputs specification of an imaged defect out of said defects, and
said inclined image acquisition step takes an image of a defect group specified by said selection step.

19. The method according to claim 16,
wherein said selection step performs a processing to the images taken in said planar image acquisition step and extracts a defect region, and further performs a processing to the images taken in said planar image acquisition step or determines automatically an image-taking direction of an inclined image based on CAD data.

20. The method according to claim 16,
wherein said selection step sets a plurality of directions for irradiating said convergent electron beam with respect to said defects to be observed, and
said inclined image acquisition step takes images of said defects to be observed from a plurality of directions set by said selection step, and displays simultaneously the images taken from said plurality of directions.
